(19) United States
(12) Patent Application Publication
(10) Pub. No.: US 2007/0261569 A1
(43) Pub. Date: Nov. 15, 2007

(54) CHICKEN WING & LEG GRILL RACK

(76) Inventors: JIM D'AMATO, GLEN ROCK, NJ (US); JOHN BATTAGLIA, HACKENSACK, NJ (US)

Correspondence Address: KALIKO & YEAGER, L.L.C., 500 NORTH FRANKLIN TURNPIKE, RAMSEY, NJ, 07446, US

(21) Appl. No.: 11/307,329

(22) Filed: Feb. 1, 2006

(51) Int. Cl. A47J 43/00

(52) U.S. Cl. 99/449

(57) ABSTRACT

A chicken leg and wing grill rack comprises a flat mounting member having a plurality of slots and apertures alternately positioned about the periphery thereof. An enlarged periphery thereof. An enlarged aperture and connecting slot are centrally located on the flat member. Chicken wings are mounted in the apertures and chicken legs are mounted in the slots. Pivotal legs are mounted on the ends of the substantially rectangular flat member to support the chicken parts at a predetermined distance above the grill and permit folding for storage purposes.

This invention relates to cooking facilities and particularly to a rack for grilling chicken legs in a new and improved manner with an inexpensive and efficient device.

In barbecuing chicken legs, it is extremely difficult to cook the legs uniformly without burning. The legs must constantly be watched and rotated on the grill. Unfortunately, even with considerable attention, it is quite easy to burn the legs or cook the legs in a non-uniform manner. The present invention is designed to permit uniform cooking of a plurality of chicken legs without the problems associated with the prior art methods. The invention comprises a unique rack, which holds the legs in a vertical position spaced at a predetermined distance above the fire for uniform cooking without the problem of burning.

In the prior art, U.S. Pat. No. 2,269,310, discloses a display device for supporting and displaying axe and shovel handles. The device includes a plurality of spaced parallel slots with openings at one end. The device is intended for a use different from the present invention and apart from apparent similarity of parallel slots is different in structure.

U.S. Pat. No. 4,554,869 is directed to an adjustable barbecue rack for supporting a plurality of spareribs. The device includes a plurality of racks removably secured to a main rack. Another version of a barbeque rack is shown is U.S. Pat. No. 4,458,585 wherein a cooking surface is defined by spaced rods formed in a particular manner.

U.S. Pat. No. 5,730,046 discloses a flat platform with downwardly extending side portions having tubular legs to support the rack at a predetermined distance above the fire.

Other patents of general interest included U.S. Pat. Nos. 4,677,906; 4,583,647; 4,765,584; 4,184,592; and, 4,542,684. None of the prior art patents mentioned above affect the patentability of the present invention, which relates to a unique rack for grilling chicken legs.

The invention relates to cooking devices and particularly to a device or rack for grilling chicken legs on a barbecue. The prior art devices for grilling chicken legs were generally no more than a open grill where the legs had to be constantly rotated to prevent burning. In the present invention, the legs are suspended from a specially designed rack at a predetermined distance above the fire to permit uniform cooking without burning.

The unique rack of the present invention comprises a flat metal structure with cutouts and with collapsible legs, which maintain the flat structure a predetermined distance above the grill. The flat structure, which is generally rectangular, includes a plurality of cutout circles and slots about the periphery to accommodate chicken wings and legs respectively. The flat structure may also include a center aperture for insertions of legs and a connecting slot to hold a plurality of legs in the slot. The rack may also include a handle and may include several apertures with connecting slots depending on the size of the rack.

In a typical embodiment, the legs comprise a wire base and upwardly extending wire members at each end of the base, which pivotably mount to downwardly extending flanges on the corners of the flat metal structure. The rack may be coated with a non-stick coating.

Accordingly, an object of this invention is to provide a new and improved grilling device for chicken legs.

Another object of this invention is to provide a new and improved barbecue rack for uniformly grilling chicken legs.

A further specific object of this invention is to provide a new and improved barbecue rack wherein a plurality of chicken legs may be mounted in an upside down position with the meaty portions extending downwardly from a plurality of slots to permit uniform grilling and prevent burning.

A more specific object of this invention is to provide an inexpensive flat metal surface having a plurality of alternating slots and circles about its periphery for holding chicken legs and wings respectively; and an enlarged hole in the surface thereof, permitting legs to be inserted through the hole and held in place along the slot with pivotal legs maintaining the flat surface a predetermined distance above the grill.

The above and other objects and advantages of the present invention may be more clearly seen when viewed in conjunction with the accompanying drawings wherein:

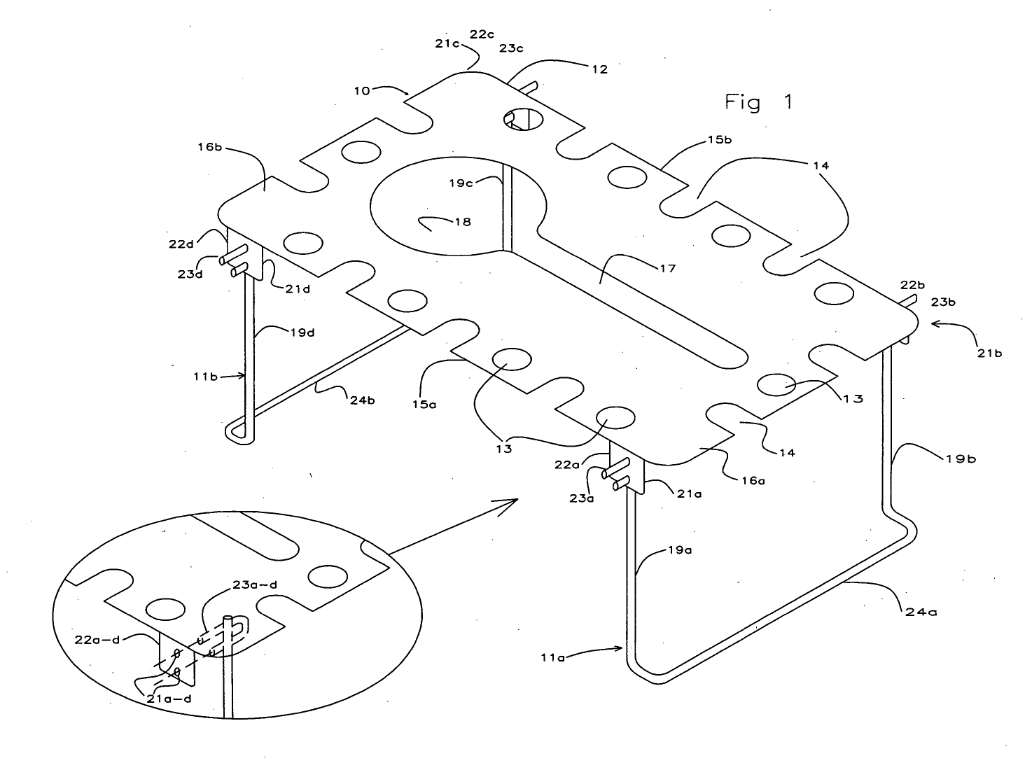

FIG. 1 is a perspective view of the unique rack comprising the invention with the rack legs in an open position for placement on a barbecue;

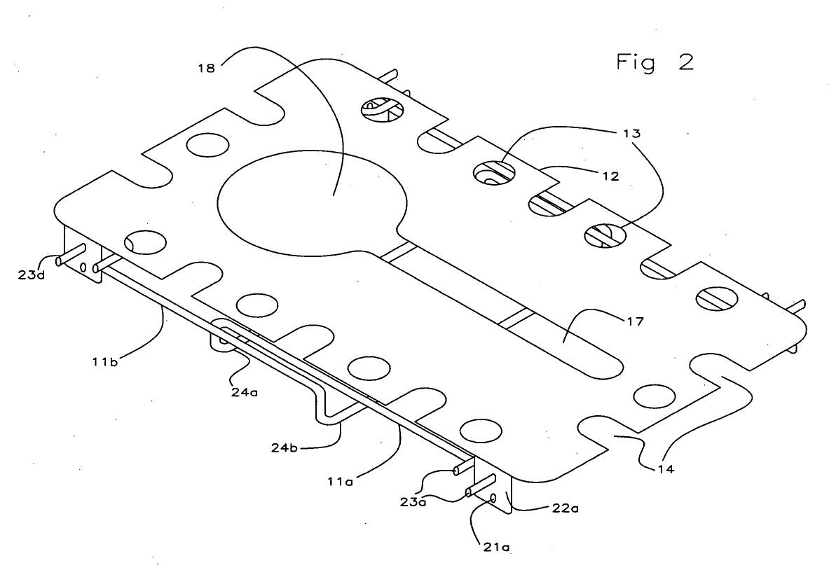

FIG. 2 is a perspective view of the new and improved rack with the rack legs in a closed position for storage purposes; and,

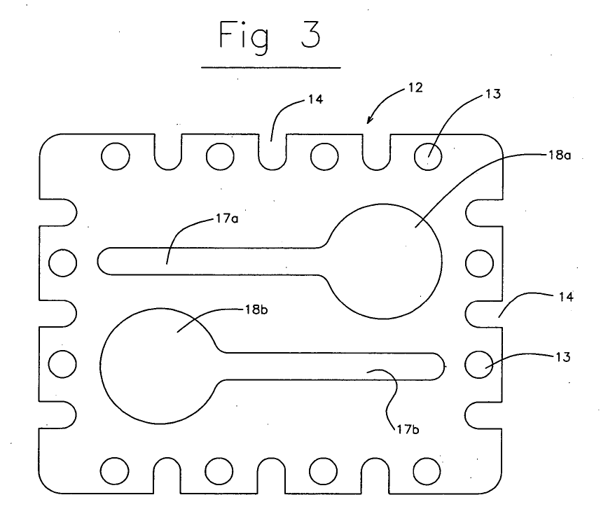

FIG. 3 is a top view of an alternate embodiment of this invention.

Referring now to FIG. 1 of the drawings, the invention comprises a grill rack 10 primarily for chicken legs and wings. The rack 10 is designed to rest on the grilling surface of a barbecue. The downwardly extending legs 11a and 11b position the flat surface 12 of the rack 10 at a predetermined distance above the grilling surface. Optionally, the flat surface 12 may be placed on the grill with the legs projecting upwardly so that skewers may be mounted between the legs 11a and 11b. The chicken legs and wings are positioned on to the flat surface 12 and extend downwardly so the legs and wings are uniformly cooked.

The flat surface or member 12 comprises a substantially rectangular metal member having a plurality of apertures 13 and slots 14 arranged along the periphery thereof. The illustration in FIG. 1 shows four apertures 13 and three slots 14 alternately arranged along the longer sides 15a and 15b of member 12 and two slots 14 and one central hole along the shorter sides 16a and 16b. The apertures 13 and slots 14 are arranged opposite a similar hole 13 or slot 14 on the other side of member 12. Having both slots 14 and apertures 13 adds to the versatility of the rack 10.

The circular apertures 13 are approximately 0.593 in diameter from one side to the other side. The apertures or holes 13 are designed to hold the irregular shape of wings while the slots 14 engage the lower bone in the chicken leg. Other shapes may be employed and the apertures 13 and the flat surface 12 could include all apertures 13 or all slots 14.

Extending longitudinally along the member 12 is a central slot 17 extending form an enlarged aperture 18. Chicken legs are inserted downwardly through the slot 17 and then fed along the slot 17 with the meaty side down to promote even cooking. Thus, a number of legs can be cooked in this slot 17. While one central slot aperture 18 is shown in FIG. 1, it is possible in larger racks to have more than one slot 17-aperture 18 as shown in FIG. 3 with slots 17a, 17b and apertures 18a, 18b.

The rack 10 includes pivotal leg members 11a and 11b at each end of the rack 10. Each leg member 11a, 11b includes upwardly extending elongated member 19a-d, which mount at one end to apertures 21a-d respectively in flanges 22a-d extending downwardly from member 12. The elongated members 19a-19d each include upper perpendicular portions 23a-23c, which engage the apertures 21a-d. The legs 11a and 11b each include an offset transverse member 22a and 22b joining the elongated members 19a-19b and 19c, 19d. In further embodiments, a t-slot or other connecting means may be used to join the legs 11a, 11b to the flat surface 12.

FIG. 2 depicts the rack in a folded position for storage or shipment with the pivoting wire legs 11a and 11b folded against one another. The legs 11a, 11b pivot about the flanges aperture 21a-21d when pressure is applied.

While the flat member 12 has been shown in a rectangular shape, other geometrical shapes can be used. The rectangular shape, however, is particularly suited for a typical barbecue. The substantially flat member 12 can be readily punched out and thus is inexpensive to produce. Furthermore, the member 12 can include a flange side portion to eliminate the individual flanges 22a-d and in some cases, the central slot/aperture can be eliminated to provide a flat cooking surface, which can have a non-stick coating. The legs 11a, 11b can also be fixedly mounted to the surface 12 and finally the rack 10 itself can be mounted to the barbecue hood to be pivoted into position when the hood is opened.

While the invention has been explained by a detailed description of certain specific embodiments, it is understood that various modifications and substitutions can be made in any of them within the scope of the appended claims that are intended also to include equivalents of such embodiments.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A rack for cooking comprising:
a substantially flat upper member having a plurality of one of apertures, slots, and apertures and slots for holding appropriately sized meats and fish; and
one or more support members attached to the substantially flat upper member to support the flat upper member.

20. The rack of claim 19, wherein the one or more support members are permanently attached to the flat upper Member.

21. The rack of claim 20, wherein the one or more support members are pivotally attached to the flat upper member.

22. The rack of claim 19, wherein the one or more support members are removably attached to the flat upper member.

23. The rack of claim 22, wherein the one or more support members are pivotally attached to the flat upper member.

24. The rack of claim 19, wherein the one or more support members are at a length determined by the user.

25. The rack of claim 19, further comprising at least one aperture with a connecting slot positioned on the flat upper member.

26. A rack for cooking comprising:
a substantially flat upper member having a plurality of one of apertures, slots, and apertures and slots for holding appropriately sized meats and fish; and
one or more support members; and
a connecting means mounted to the flat upper member; wherein the one or more support members are attached to the connecting means in order to support the flat upper member.

27. The rack of claim 26, wherein the one or more support members are permanently attached to the connecting means.

28. The rack of claim 27, wherein the one or more support members are pivotally attached to the connecting means.

29. The rack of claim 26, wherein the one or more support members are removably attached to the connecting means.

30. The rack of claim 29, wherein the one or more support members are pivotally attached to the connecting mean.

31. The rack of claim 26, wherein the one or more support members are at a length determined by the user.

32. The rack of claim 26, further comprising at least one aperture with a connecting slot positioned on the flat upper member.

33. A method for cooking meats and fish comprising the steps of:
providing a substantially flat upper member having a plurality of one of apertures, slots, and apertures and slots for holding appropriately sized meats and fish; and
providing one or more support members attached to the substantially flat upper member to support the flat upper member.

34. The method in accordance with claim 33, further comprising the step of providing at least one aperture with connecting slot in the substantially flat surface.

35. A method for cooking meats and fish comprising the steps of:
providing a substantially flat upper member having a plurality of one of apertures, slots, and apertures and slots for holding appropriately sized meats and fish;
providing one or more support members; and
providing a connecting means mounted to the flat upper member; wherein the one or more support members are attached to the connecting means in order to support the flat upper member.

36. The method in accordance with claim 35, further comprising the step of providing at least one aperture with connecting slot in the substantially flat surface.

37. A rack for cooking comprising:
a substantially flat upper member having a plurality of one of slots, apertures, and slots and apertures for holding appropriately sized meats and fish; and
one or more support members with a first end and a second end, wherein the first end is attached to one of a connecting means and the substantially flat upper member and the second end is attached to a barbecue grill grate.

38. The method in accordance with claim 37, further comprising the step of providing at least one aperture with connecting slot in the substantially flat surface.

39. A rack for cooking comprising:
a substantially flat upper member having a plurality of one of slots, apertures, and slots and apertures for holding appropriately sized meats and fish; and
one or more support members with a first end and a second end, wherein the first end is connected to one of a connecting means and the substantially flat upper member and the second end is connected to a barbecue grill body, wherein the barbecue grill body is at least one of the sides of the grill, the front of the grill, the back of the grill, and the hood of the grill.

40. The method in accordance with claim 39, further comprising the step of providing at least one aperture with connecting slot in the substantially flat surface.
